(19) United States
(12) Patent Application Publication
(10) Pub. No.: US 2019/0194957 A1
(43) Pub. Date: Jun. 27, 2019

(54) Telescoping Break-Away Canopy Assembly

(71) Applicant: Wurtec, Incorporated, Toledo, OH (US)

(72) Inventors: Steven P. Wurth, Sylvania, OH (US); Terry Rodebaugh, Whitehouse, OH (US)

(73) Assignee: Wurtec, Incorporated, Toledo, OH (US)

(21) Appl. No.: 16/222,258

(22) Filed: Dec. 17, 2018

Related U.S. Application Data
(60) Provisional application No. 62/609,411, filed on Dec. 22, 2017.

(51) Int. Cl. E04G 5/12; B66B 5/00; E04G 3/28; E04G 5/14

(52) U.S. Cl. CPC E04G 5/12; B66B 5/005; E04G 2005/125; E04G 5/142; E04G 2003/286; E04G 3/28

(57) ABSTRACT

A break-away canopy assembly configured for use with a work platform in an elevator hoistway is provided. The break-away canopy assembly includes a plurality of spaced apart canopy posts in a substantially vertical orientation. A first support framework is connected to one or more of the spaced apart canopy posts. A second support framework is connected to one or more of the spaced apart canopy posts and opposes the first support framework. The first and second support frameworks each have connected first and second extension assemblies. One or more roof sections span and are connected to the first and second support frameworks. The first and second extension assemblies of the first support framework and the first and second extension assemblies of the second support frameworks are each configured to separate from each other in the event of an uncontrolled descent of the work platform.

### CROSS-REFERENCE TO RELATED APPLICATIONS

This application claims the benefit of U.S. Provisional Patent Application No. 62/609,411 filed Dec. 22, 2017, the disclosure of which is incorporated herein by reference in its entirety.

### BACKGROUND

Elevators are typically constructed within a building structure commonly referred to as an elevator hoistway. In some instances, elevator hoistways can be defined by four walls that extend from a lower level of the building (referred to as a pit) to an upper level of the building. The hoistway walls can be formed from a variety of materials including cement, concrete block, drywall and glass block. In other instances, the hoistway can be formed by metal structures, such as for example, beams configured to surround the space forming the hoistway.

Various components forming the elevator, such as for example, rails, electrical switches, hoistway doors and electrical conduit can be attached to the hoistway walls or the beams at various vertical levels of the hoistway.

During construction or subsequent maintenance of the elevator, it can be desirable to have a temporary work platform and/or work surface within the hoistway. The temporary work platform can be used by construction or maintenance personnel as a support platform from which various elevator components forming the elevator can be attached to the hoistway walls or beams. The temporary work platform can also be used as a temporary storage area for components to be attached to the hoistway walls or beams. It is common that the temporary work platform is moved from one level of the hoistway to another level of the hoistway as the construction or maintenance of the elevator proceeds.

In certain instances, the temporary work platform is formed from scaffolding consisting of a modular system of metal pipes or tubes, couplers and boards. In this system, the metal pipes and couplers are used form a structure upon which the boards (or similar materials) are installed to form a working platform. As the work progresses within the elevator hoistway, additional scaffolding can be added to the existing scaffolding in order to locate the working platform to higher levels.

In other instances, a device called a false car can be used as a temporary work platform. A false car can be suspended from an upper hoistway location and can travel vertically within the hoistway on a separate hoist rope by means of a winch mounted on the false car.

It would be advantageous if false cars could be equipped with structures comprising a protective canopy.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the telescoping break-away canopy assembly.

The above objects as well as other objects not specifically enumerated are achieved by a break-away canopy assembly configured for use with a work platform in an elevator hoistway. The break-away canopy assembly includes a plurality of spaced apart canopy posts configured in a substantially vertical orientation. A first support framework is connected to one or more of the spaced apart canopy posts. The first support framework has connected first and second extension assemblies. A second support framework is connected to one or more of the spaced apart canopy posts and opposes the first support framework. The second support framework has connected first and second extension assemblies. One or more roof sections span and are connected to the first and second support frameworks. The first and second extension assemblies of the first support framework and the first and second extension assemblies of the second support frameworks are each configured to separate from each other in the event of an uncontrolled descent of the temporary work platform.

Various aspects of the telescoping break-away canopy assembly will become apparent to those skilled in the art from the following detailed description of the illustrated embodiments, when read in light of the accompanying drawings.

### BRIEF DESCRIPTION OF THE DRAWINGS

FIG. 1 is a schematic perspective view of a canopy assembly mounted to and supported by a platform assembly.

FIG. 2 is a perspective view of a portion of the canopy assembly of FIG. 1 illustrating a canopy post attached to a first extension assembly.

FIG. 3 is a side view of a portion of the canopy assembly of FIG. 1 illustrating cooperating first and second extension assemblies.

FIG. 4 is a perspective view of a portion of the first and second extension assemblies of FIG. 3 illustrating a hitch roof tube and a tube receiver assembly.

FIG. 5 is an exploded perspective view of a first extension assembly of the canopy assembly of FIG. 1.

FIG. 6 is a front view of the first and second extension assemblies of FIG. 1 shown in an installed orientation.

FIG. 7 is a perspective view of the first and second extension assemblies of FIG. 1 shown with installed roof sections.

FIG. 8 is a front view of an alternate structure used to secure the roof section of FIG. 7.

FIG. 9 is a schematic perspective view of the canopy assembly of FIG. 1 mounted to and supported by an elevator crosshead.

FIG. 10 is a schematic perspective view of the canopy assembly of FIG. 1 mounted to and supported by an elevator cab.

### DETAILED DESCRIPTION

The telescoping break-away canopy assembly will now be described with occasional reference to the specific embodiments. The telescoping break-away canopy assembly may, however, be embodied in different forms and should not be construed as limited to the embodiments set forth herein. Rather, these embodiments are provided so that this disclosure will be thorough and complete, and will fully convey the scope of the telescoping break-away canopy assembly to those skilled in the art.

Unless otherwise defined, all technical and scientific terms used herein have the same meaning as commonly understood by one of ordinary skill in the art to which the telescoping break-away canopy assembly belongs. The terminology used in the description of the telescoping break-away canopy assembly herein is for describing particular embodiments only and is not intended to be limiting of the telescoping break-away canopy assembly. As used in the description of the telescoping break-away canopy assembly and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the telescoping break-away canopy assembly. Notwithstanding that the numerical ranges and parameters setting forth the broad scope of the telescoping break-away canopy assembly are approximations, the numerical values set forth in the specific examples are reported as precisely as possible. Any numerical values, however, inherently contain certain errors necessarily resulting from error found in their respective measurements.

The description and figures disclose a telescoping break-away canopy assembly (hereafter “canopy assembly”) for use with a work platform within an elevator hoistway. The work platform can have different forms, including a temporary work platform. One non-limiting example of a temporary work platform is a false car. The false car can be suspended from one or more hoist ropes and can be configured for vertical movement from one level of the elevator hoistway to another level. Generally, the canopy assembly is connected to and disposed above the temporary work platform in a manner such that the canopy assembly is separable in the event of an uncontrolled descent of the temporary work platform.

The term “elevator hoistway,” as used herein, is defined to mean a vertically oriented space within a building within which one or more elevators, dumbwaiters, or material lifts travel vertically. The term “false car” as used herein, is defined to mean a vertically movable platform configured for use by elevator personnel.

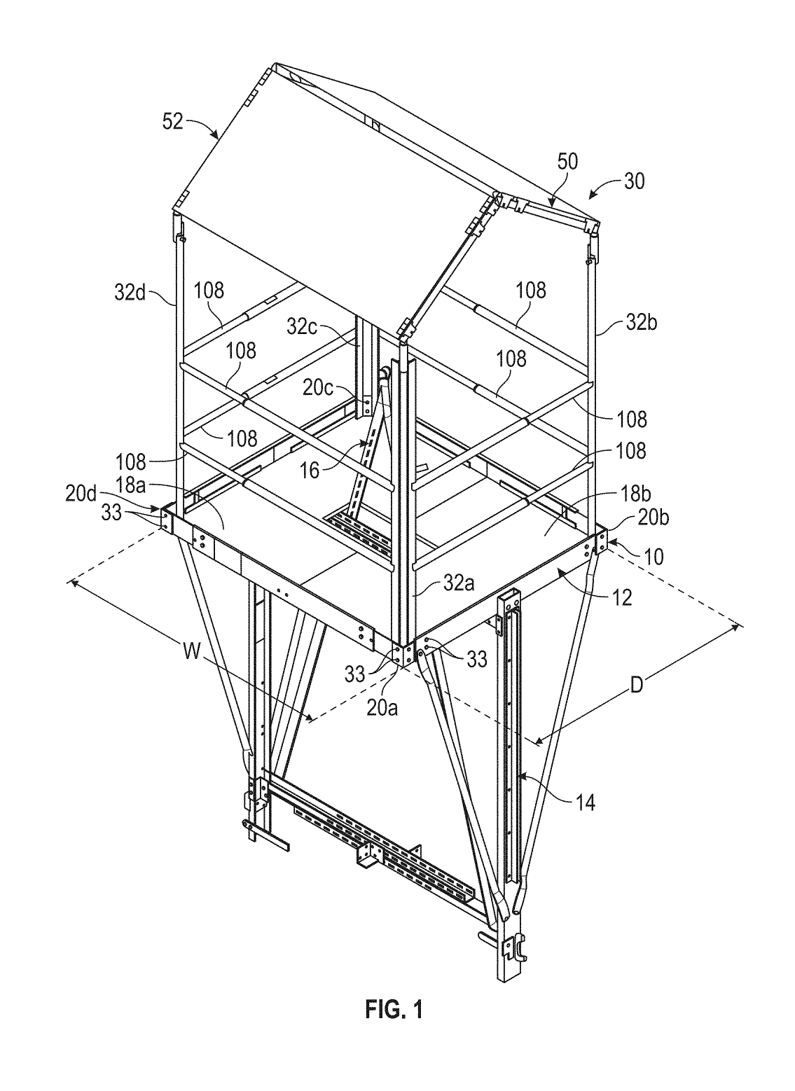

Referring now to FIG. 1, one embodiment of a temporary work platform is shown generally at 10. The temporary work platform 10 is configured to provide a work surface within a hoistway during construction or subsequent maintenance of the elevator. The temporary work platform 10 includes a platform assembly 12, a frame assembly 14 and a lift assembly 16. Generally, the platform assembly 12 is attached to and supported by the frame assembly 14, and the lift assembly 16 is configured to facilitate hoisting of the platform assembly 12 and the frame assembly 14 within the elevator hoistway by one or more hoist ropes (not shown for purposes of clarity). In the embodiment of the temporary work platform 10 illustrated in FIG. 1, the temporary work platform 10 has the form of a false car. One non-limiting example of a false car is provided in pending U.S. patent application Ser. No. 15/119,733 filed Aug. 18, 2016 and titled “False Car Device”, the disclosure of which is incorporated herein by reference in its entirety. However, it should be appreciated that in other embodiments, the temporary work platform 10 can have other forms sufficient to provide a work surface within a hoistway during construction or subsequent maintenance of the elevator.

Referring again to FIG. 1, the platform assembly 12 includes a plurality of platform surfaces 18a, 18b supported by the frame assembly 14. The platform surfaces 18a, 18b are configured to provide a work surface within an elevator hoistway. Optionally, the platform surfaces 18a, 18b can be removed from the frame assembly 14.

Referring again to FIG. 1, the platform assembly 12 includes a plurality of spaced-apart corner members 20a-20d. The corner members 20a-20d will be discussed in more detail below.

Referring again to FIG. 1, the platform assembly 12 has a width W and a depth D. In the illustrated embodiment, the width W and the depth D of the platform assembly 12 are adjustable, thereby facilitating adjustment of the platform assembly 12 to the inner dimensions of the elevator hoistway. In the illustrated embodiment, the platform assembly 12 has an adjustable width W in a range of from about 72.0 inches to about 96.0 inches and an adjustable depth D in a range of from about 61 inches to about 75 inches. However, in other embodiments, the platform assembly 12 can have a width W less than about 72.0 inches or more than about 96.0 inches and a depth D less than about 61 inches or more than about 75 inches. In still other embodiments, the width W and the depth D of the platform assembly 12 need not be adjustable.

Referring again to FIG. 1, the platform assembly 12 is configured to support a canopy assembly 30. The canopy assembly 30 extends vertically in an upward direction from the platform assembly 12, in a manner such that the canopy assembly 30 is separable in the event of an uncontrolled descent of the work platform 10.

Referring again to FIG. 1, the canopy assembly 30 includes a plurality of canopy posts 32a-32d, connected to and extending in an upward direction from an associated corner member 20a-20d. In the illustrated embodiment, the canopy posts 32a-32d are connected to the associated corner member 20a-20d with fastening hardware 33, such as for example a threaded bolt and nut. In alternate embodiments, other structures, mechanisms and devices can be used to connect the canopy posts 32a-32d to the associated corner member 20a-20d.

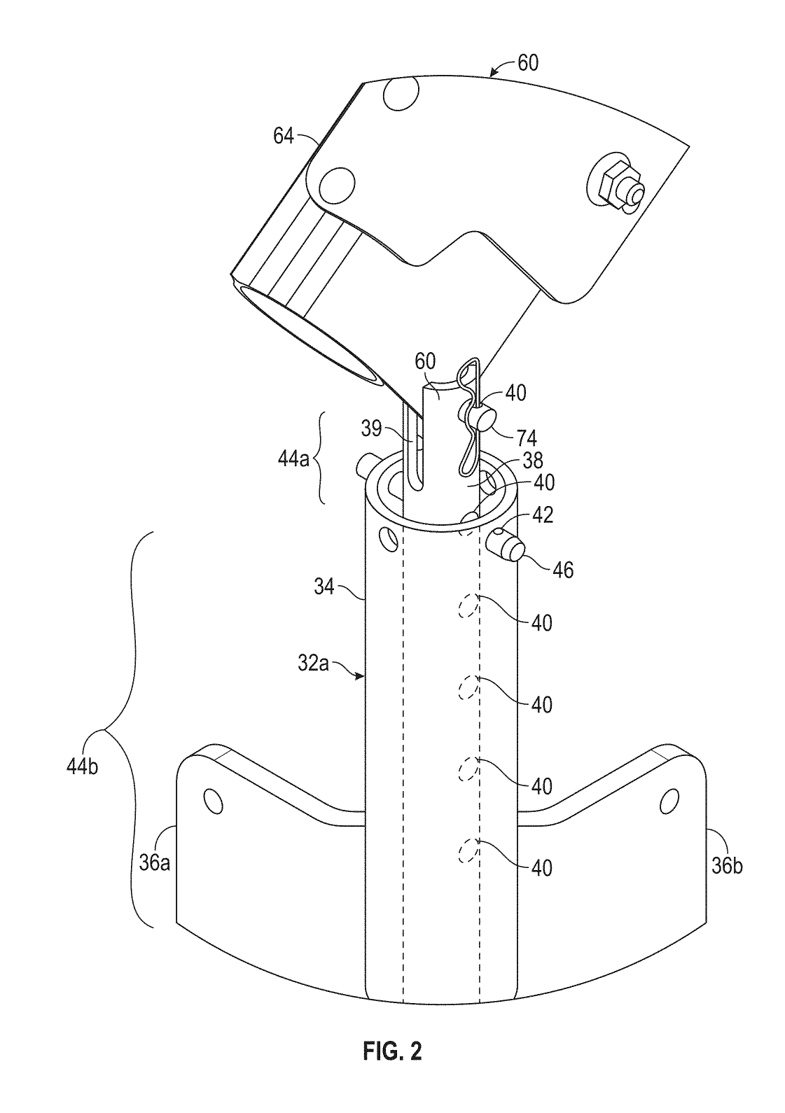

Referring now to FIG. 2, the canopy post 32a is illustrated. The canopy post 32a is representative of the canopy posts 32b-32d. The canopy post 32a includes a hollow, tubular member 34 connected to opposing flanges 36a, 36b. The tubular member 34 is configured to receive a hinge tube 38, such that the hinge tube 38 is arranged in a co-axial manner with the tubular member 34 and is slidable within the tubular member 34. The hinge tube 38 includes a plurality of apertures 40 spaced apart along the hinge tube 38. The apertures 40 are configured to correspond to apertures 42 extending through the tubular member 34. An upper portion 44a of the hinge tube 38 extends from the end of the tubular member 34 in a vertically upward direction and a lower portion 44b of the hinge tube 38 extends in a vertically downward direction within the tubular member 34. A fastener 46, such as the non-limiting example of a quick release pin, extends through the apertures 42 in the tubular member 34 and the apertures 40 in the hinge tube 38, thereby setting a desired height of the upper portion 44a of the hinge tube 38 extending from the tubular member 34. The fastener 46 is configured to facilitate quick disassembly and readjustment of the height of the upper portion 44a of the hinge tube 38 as the hinge tube slides within the tubular member 34. It should be appreciated that other suitable fasteners 46 can be used sufficient to facilitate quick disassembly and readjustment of the height of the upper portion 44a of the hinge tube 38 as the hinge tube slides within the tubular member 34.

Referring again to FIG. 2, the upper portion 44a of the hinge tube 38 includes a slot 39. The slot 39 is axially aligned with the hinge tube 38. The slot 39 will be discussed in more detail below.

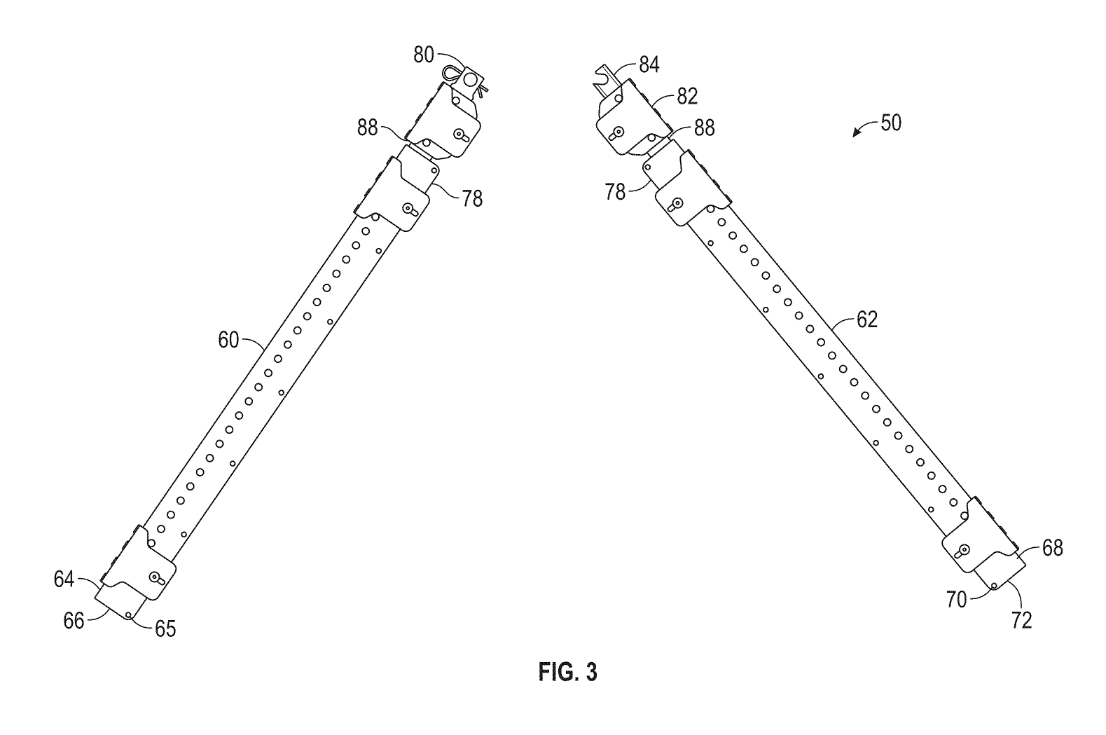

Referring again to FIG. 1, the canopy assembly 30 includes a first support framework 50 and an opposing second support framework 52. Referring now to FIG. 3, the first support framework 50 is illustrated. The first support framework 50 is representative of the second support framework 52. The first support framework 50 includes a first extension assembly 60 and an opposing second extension assembly 62. As will be discussed in more detail below, the first and second extension assemblies 60, 62 are configured for telescoping actions, in manners such that the size, slope, configuration and arrangement of the first support framework 50 can be adjusted.

Referring now to FIGS. 2 and 3, a lower end 64 of the first extension assembly 60 includes an aperture 65 and a lower portion 66. In a similar manner, a lower end 68 of the second extension assembly 62 includes an aperture 70 and a lower portion 72. The apertures 65, 70 and lower portions 66, 72 will be discussed in more detail below.

Referring now to FIG. 2 in an assembly arrangement, the first extension assembly 60 is attached to the hinge tube 38 as the lower portion 66 of the first extension assembly 60 is received in the slot 39 and a fastener 74 extends through an uppermost aperture 40 in the hinge tube 38 and the aperture 65 in the first extension assembly 60. The second extension assembly 62 is attached to a hinge tube 38 in a similar manner. The fastener 74 is configured to facilitate quick assembly and disassembly of the first extension assembly 60 to the hinge tube 38. In the illustrated embodiment, the fastener 74 is a quick release pin. However, in other embodiments, other suitable fasteners 74 can be used sufficient to facilitate quick assembly and disassembly of the first extension assembly 60 to the hinge tube 38.

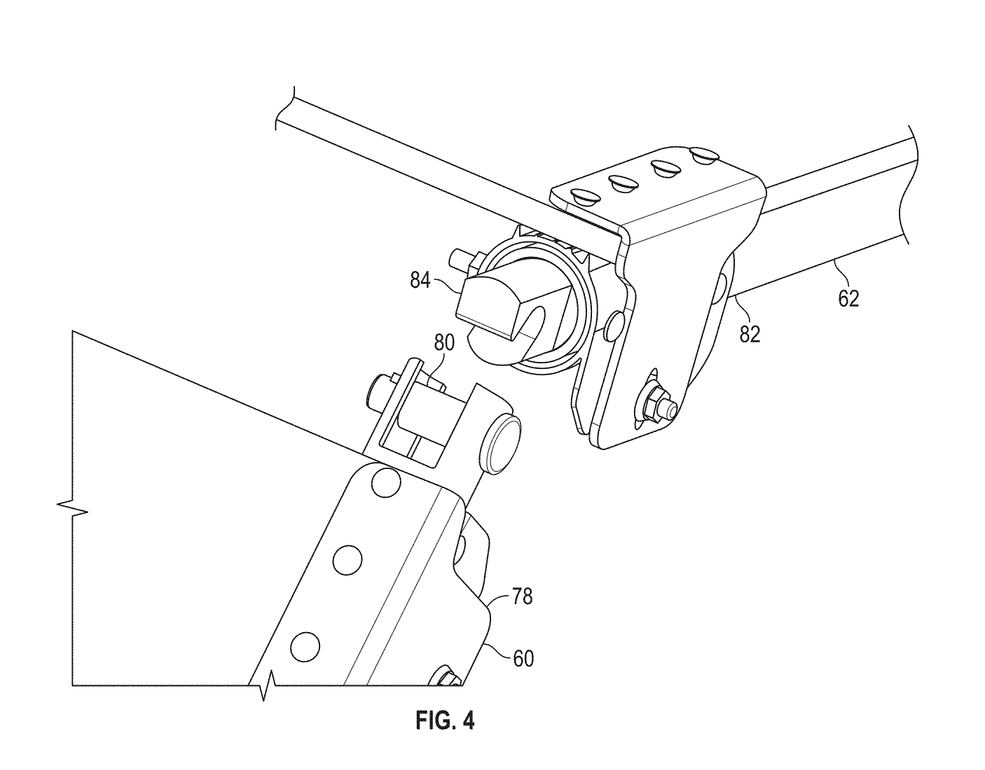

Referring again to FIG. 3, an upper end 78 of the first extension assembly 60 includes a hitch roof tube 80 and an upper end 82 of the second extension assembly 62 includes a tube receiver assembly 84. Referring now to FIG. 4, the hitch roof tube 80 of the first extension assembly 60 and tube receiver assembly 84 of the second extension assembly 62 are illustrated. The tube receiver assembly 84 is configured to receive the hitch roof tube 80, thereby connecting the first extension assembly 60 to the second extension assembly 62. It should be appreciated that the connecting structures of the hitch roof tube 80 and the tube receiver assembly 84 facilitate a breakaway structure. That is, in the event of an uncontrolled descent of the temporary work platform 10, the hitch roof tube 80 and the tube receiver assembly 84 are configured to separate from the canopy posts 32a-32d and/or separate from each other. Advantageously, the breakaway structure is configured to prevent the canopy assembly 30 from causing injury to personnel connected to the canopy assembly 30 with typical fall protection equipment.

While the embodiment illustrated in FIGS. 3 and 4 are shown with the hitch roof tube 80 and the tube receiver assembly 84, in other embodiments other connecting structures and devices can be used sufficient to breakaway from the canopy posts 32a-32d and/or separate from each other in the event of an uncontrolled descent of the temporary work platform.

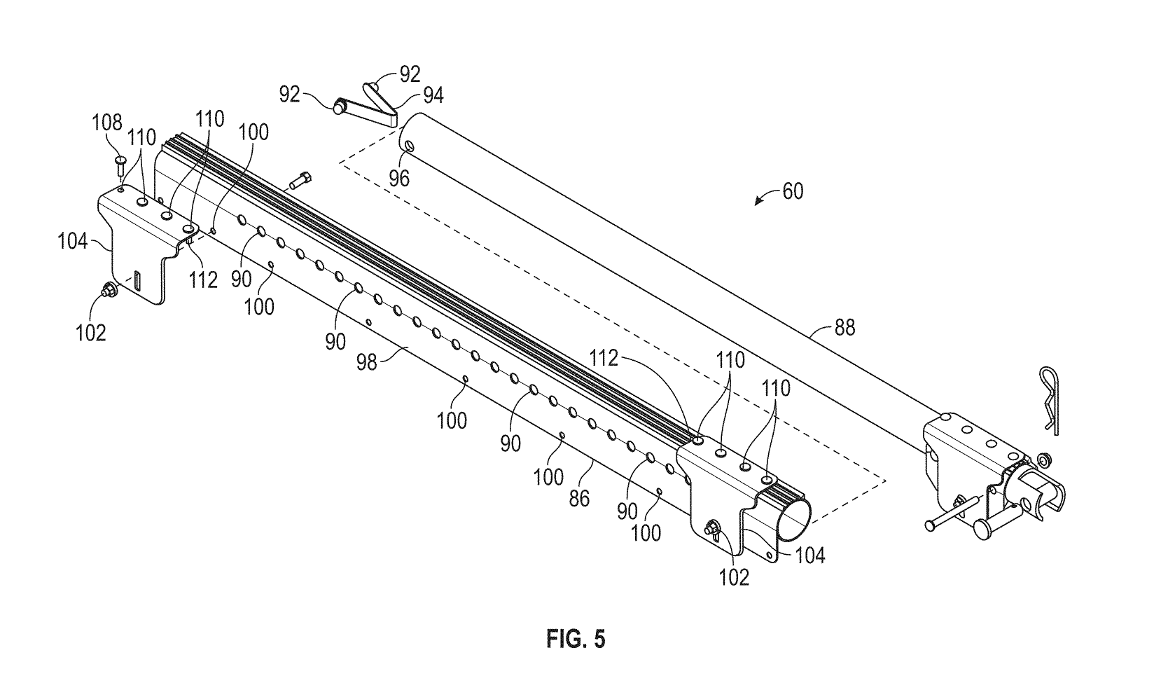

Referring now to FIG. 5, the first extension assembly 60 is illustrated in an exploded view. The first extension assembly 60 is generally representative of the second extension assembly 62. The first extension assembly 60 includes an outer, hollow member 86 configured to slidably receive an inner member 88. The outer member 86 includes a plurality of spaced apart apertures 90. The spaced apart apertures 90 are configured to receive projections 92 extending from a fastener 94. As shown in FIG. 5, the projections 92 extend through apertures 96 located in the inner member 88 and engage the apertures 90 in the outer member 86. In this manner, the inner member 88 can be secured to the outer member 86 in a telescoping arrangement. In the illustrated embodiment, the fastener 94 has the form of a quick-release button connector. However, other suitable fasteners can be used.

Referring again to FIG. 5, the outer member 86 includes a planar segment 98 arranged in a substantially vertical orientation. The planar segment 98 includes a plurality of spaced apart apertures 100. The plurality of spaced apart apertures 100 are configured to receive fasteners 102 in a manner such as to attach support brackets 104 to the outer member 86. The support brackets 104 are locatable along the length of the outer member 86. The support brackets 104 will be discussed in more detail below.

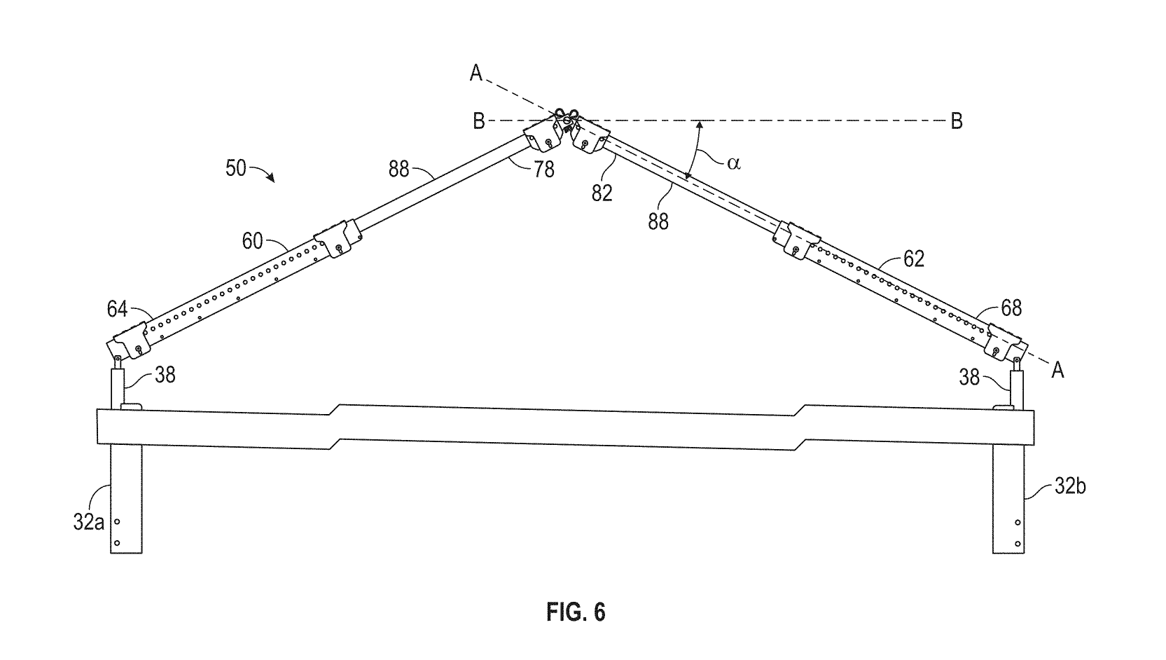

Referring now to FIG. 6, the first support assembly 50 is shown in a deployed orientation with the lower end 64 of the first extension assembly 60 secured to the hinge tube 38 extending from the canopy post 32a and with the lower end 68 of the second extension assembly 62 secured to the hinge tube 38 extending from the canopy post 32b. The inner members 88 are extended such that the upper ends 78, 82 of the first and second extension assemblies 60, 62 are secured together as described above. In this orientation, a longitudinal axis A-A of the second extension assembly 62 forms an angle α with a substantially horizontal line, as depicted by line B-B. Advantageously, the angle α is adjustable to compensate for varying hoistway dimensions and desired slope angles. In the illustrated embodiment, the angle α is in a range of from about 10° to about 40°. However, in other embodiments, the angle α can be less than about 10° or more than about 40°, sufficient to compensate for the hoistway dimensions and desired slope angle. It should also be appreciated that the angle of the first extension assembly 60 with respect to a substantially horizontal line can be different from an angle formed by the second extension assembly 62 with respect to a substantially horizontal line.

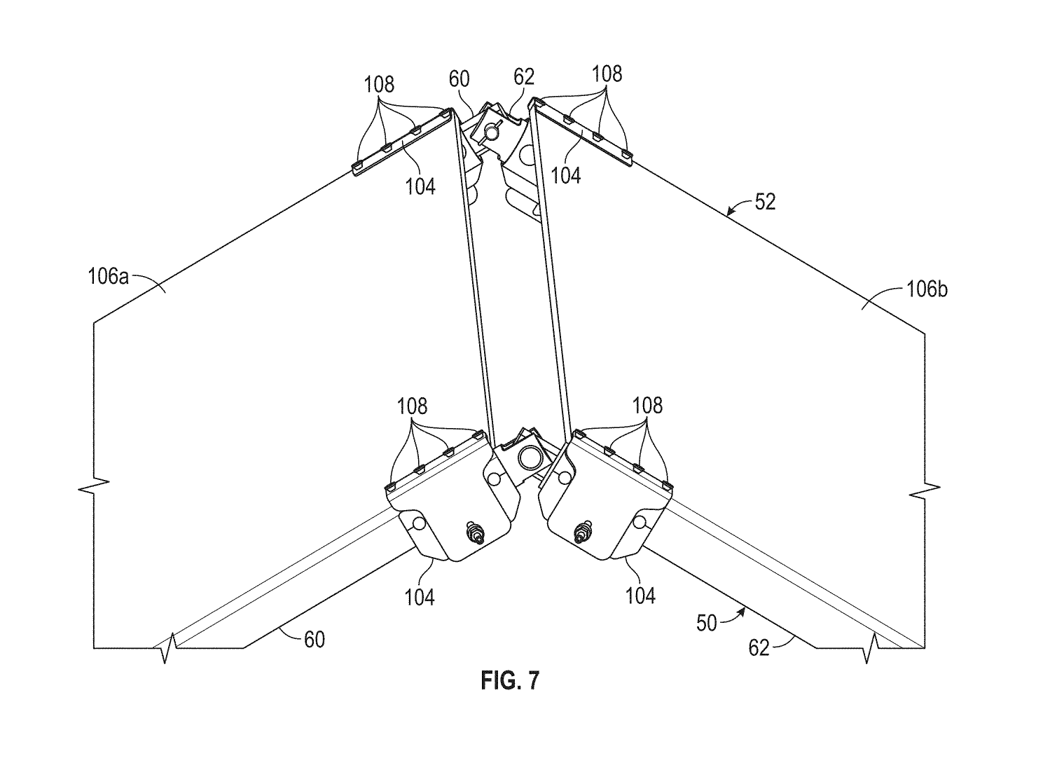

Referring now to FIGS. 5 and 7, the first and second support assemblies 50, 52 are shown in an assembled and deployed orientation. Each of the first and second support assemblies 50, 52 has the first and second extension assemblies 60, 62. The support brackets 104 are attached to the first and second extension assemblies 60, 62 as discussed above and shown in FIG. 5. The upper surfaces of the first and second support assemblies 50, 52 are configured to receive a plurality of roof sections 106a, 106b. The roof sections 106a, 106b are secured to the upper surfaces of the first and second support assemblies 50, 52 with a plurality of fasteners 108 extending through corresponding apertures 110 in an upper portion 112 of the support brackets 104. The roof sections 106a, 106b are configured to provide protection from objects falling from overhead within the elevator hoistway.

Referring again to the embodiment illustrated in FIG. 7, the roof sections 106a, 106b are formed from plywood sheets. However, in other embodiments, the roof sections 106a, 106b can be formed from other desired materials sufficient to provide protection from objects falling from overhead within the elevator hoistway. Advantageously, the roof sections 106a, 106b can be sized and positioned as desired on the upper surfaces of the first and second support assemblies 50, 52.

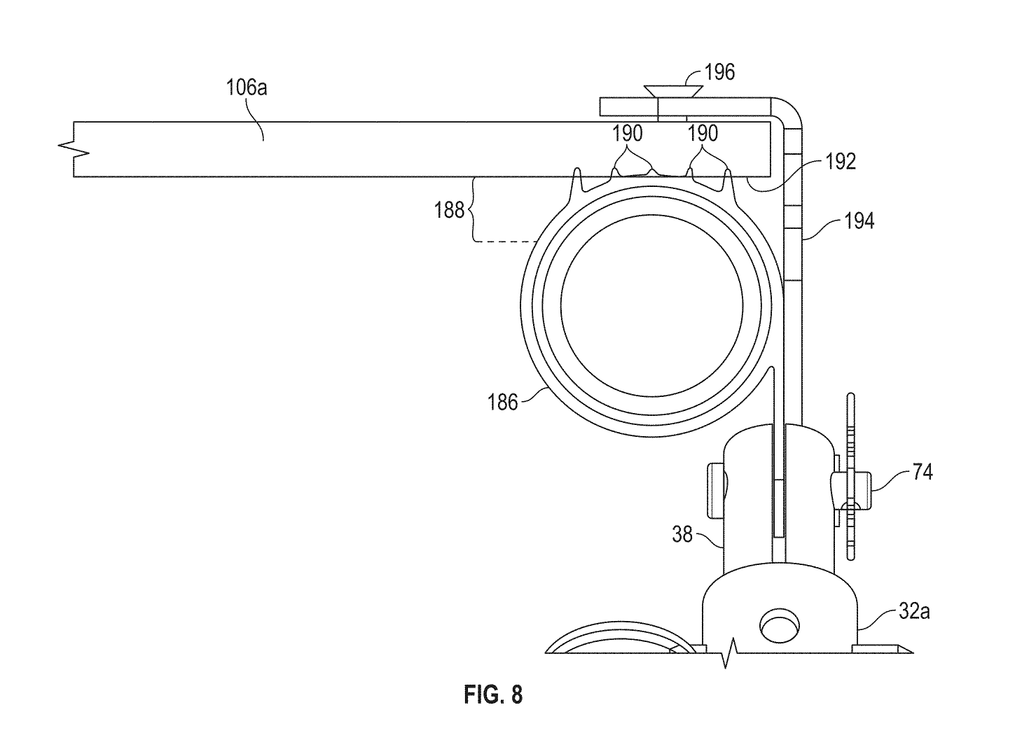

While FIGS. 4-7 illustrate the use of the support brackets 104 to secure the roof sections 106a, 106b to the upper surfaces of the first and second support assemblies 50, 52, it is contemplated that other structures, mechanisms and devices can be used. Referring now to FIG. 8, one non-limiting example of alternate structure used to secure the roof section 106a is illustrated. An outer member 186 is illustrated in a deployed orientation relative to the canopy post 32a, hinge tube 38 and fastener 74. An upper surface 188 of the outer member 186 includes surface features 190 extending along a desired length of the upper surface 188. The surface features 190 are configured to engage a lower surface 192 of the roof section 106a. An angled member 194 is positioned atop of the roof section 106a and fasteners 196 extend through the angle member 194 and into the roof section 106a. The angled member 194 is attached to the apertures in the outer member 186 with fasteners (not shown for purposes of clarity), thereby fixing the roof section 106a in place.

Referring now to FIG. 1, in certain embodiments the canopy assembly 30 can include a plurality of optional handrail assemblies 108 extending between and attached to the flanges 36a, 36b of the canopy posts 32a-32d. The handrail assemblies 108 are configured to provide structural support to the canopy assembly and further configured to provide fall protection for personnel working on the support surfaces 18a, 18b. In certain embodiments, the handrail assemblies 108 can have a telescoping structure sufficient to adjust to varying hoistway dimensions. However, it should be appreciated that the handrail assemblies 108 are optional and not required for operation of the canopy assembly 30.

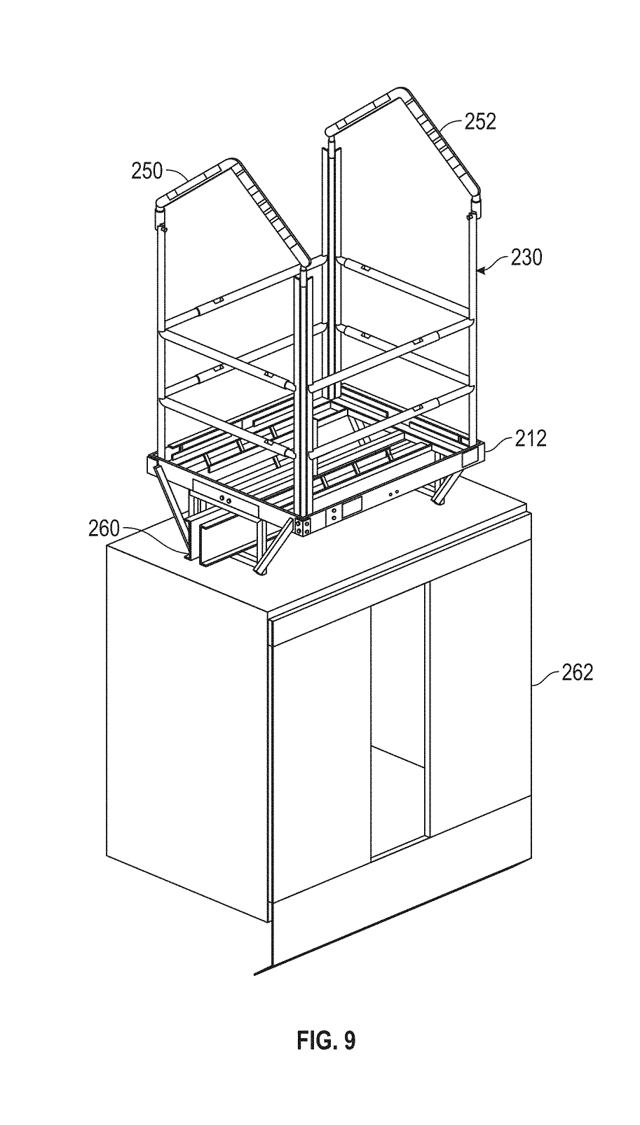

While the canopy assembly 30 is shown in FIG. 1 and described above as being mounted to and supported by the temporary work platform of a false car, it is contemplated that the canopy assembly can be mounted to and supported by other structures, including structures positioned in a hoistway for long-term use. Referring now to FIG. 9, a canopy assembly 230 is illustrated as being mounted to and supported by an elevator crosshead 260. The canopy assembly 230 includes first and second support frameworks 250, 252. In the illustrated embodiment, the first and second support frameworks 250, 252 are the same as, or similar to the first and second frameworks 50, 52 illustrated in FIGS. 1 and 3. However, in alternate embodiments, the first and second support frameworks 250, 252 can be different from the first and second frameworks 50, 52.

Referring again to FIG. 9, the term “elevator crosshead”, as used herein, is defined to mean an upper structural portion of an elevator sling. The term “elevator sling”, as used herein, is defined to mean a framework configured to enclose and support an elevator cab. In the embodiment shown in FIG. 9, the elevator crosshead 260 is connected to the elevator sling (not shown for purposes of clarity) and the elevator sling is configured to enclose and support the elevator cab 262. The elevator sling and the elevator cab 262 are configured as permanent structures within the elevator hoistway and further configured for vertical movement within the elevator hoistway as urged by one or more hoist ropes (not shown for purposes of clarity).

Referring again to FIG. 9, the canopy assembly 230 is connected to a platform assembly 212, which in turn is mounted to the elevator crosshead 260. However, it should be appreciated that in other embodiments, the canopy assembly 230 can be mounted to other work platforms and/or sling-related structures.

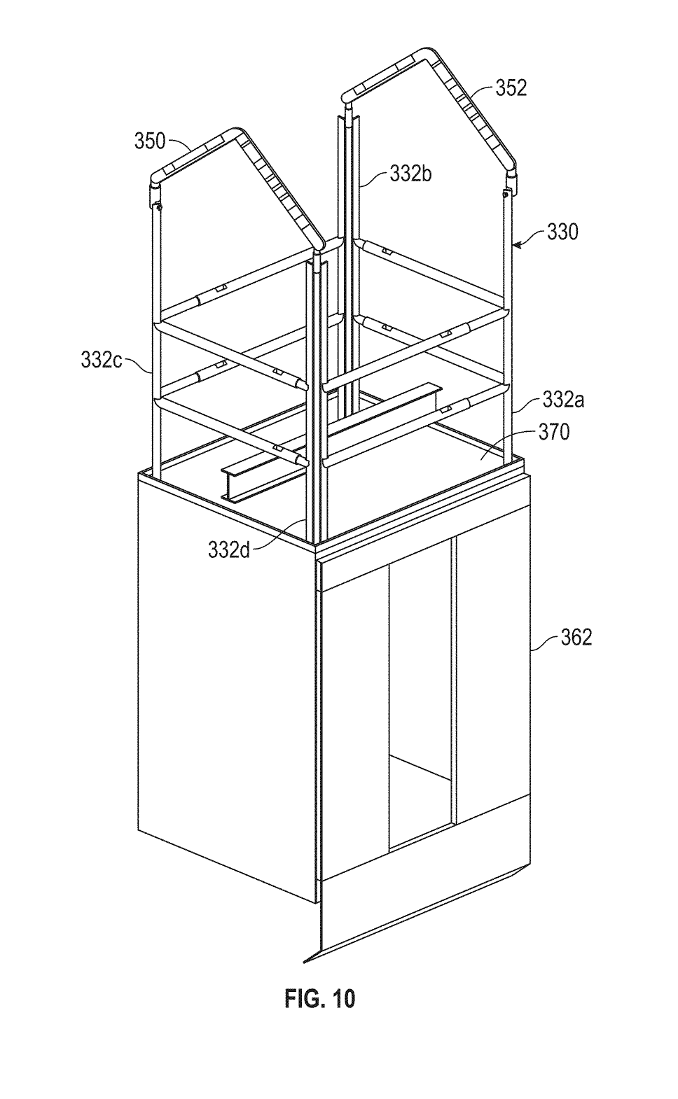

Referring now to FIG. 10, it is further contemplated that in another embodiment a canopy assembly 330 can be mounted to and supported by an elevator cab 362. The canopy assembly 330 includes first and second support frameworks 350, 352. In the illustrated embodiment, the first and second support frameworks 350, 352 are the same as, or similar to the first and second frameworks 50, 52 illustrated in FIGS. 1 and 3. However, in alternate embodiments, the first and second support frameworks 350, 352 can be different from the first and second frameworks 50, 52.

In the embodiment shown in FIG. 10, a plurality of canopy posts 332a-332d extend in a substantially vertical direction from an upper surface 370 of the elevator cab 362. The canopy posts 332a-332d are the same as, or similar to, the canopy posts 32a-32d shown in FIGS. 1 and 2 and described above. However, in other embodiments, the canopy posts 332a-332d can be different from the canopy posts 32a-32d.

In accordance with the provisions of the patent statutes, the principle and mode of operation of the telescoping break-away canopy assembly have been explained and illustrated in a certain embodiment. However, it must be understood that the telescoping break-away canopy assembly may be practiced otherwise than as specifically explained and illustrated without departing from its spirit or scope.

What is claimed is:

1. A break-away canopy assembly configured for use with a work platform in an elevator hoistway, the break-away canopy assembly comprising:
a plurality of spaced apart canopy posts configured in a substantially vertical orientation;
a first support framework connected to one or more of the spaced apart canopy posts, the first support framework having connected first and second extension assemblies;
a second support framework connected to one or more of the spaced apart canopy posts and opposing the first support framework, the second support framework having connected first and second extension assemblies; and
one or more roof sections spanning and connected to the first and second support frameworks;
wherein the first and second extension assemblies of the first support framework and the first and second extension assemblies of the second support frameworks are each configured to separate from each other in the event of an uncontrolled descent of the work platform.

2. The break-away canopy assembly of claim 1, wherein the plurality of spaced apart canopy posts are mounted to and supported by a false car.

3. The break-away canopy assembly of claim 1, wherein the plurality of spaced apart canopy posts are connected to a platform assembly and the platform assembly is mounted to and supported by an elevator crosshead.

4. The break-away canopy assembly of claim 1, wherein the plurality of spaced apart canopy posts are mounted to and supported by an upper surface of an elevator cab.

5. The break-away canopy assembly of claim 1, wherein each of the plurality of spaced apart canopy posts includes a hinge tube.

6. The break-away canopy assembly of claim 5, wherein an upper portion of each of the hinge tubes includes a slot configured to receive a portion of the first or second extension assemblies.

7. The break-away canopy assembly of claim 5, wherein an upper portion of each of the hinge tubes includes an aperture configured to receive a fastener in a manner such as to attach the first or second extension assemblies to the hinge tube.

8. The break-away canopy assembly of claim 5, wherein each of the hinge tubes is configured for a telescoping style attachment to the plurality of spaced apart canopy posts.

9. The break-away canopy assembly of claim 1, wherein each of the plurality of spaced apart canopy posts includes opposing flanges configured for connection to optional handrail assemblies.

10. The break-away canopy assembly of claim 1, wherein each of the first and second extension assemblies of the first and second support frameworks have an inner member and an outer member assembled together in a slidable, telescoping co-axial arrangement.

11. The break-away canopy assembly of claim 10, wherein the outer member includes a planar segment arranged in a substantially vertical orientation.

12. The break-away canopy assembly of claim 11, wherein the planar segment includes a plurality of spaced apart apertures configured to support one or more support brackets.

13. The break-away canopy assembly of claim 1, wherein each of the first extension assemblies includes a hitch roof tube.

14. The break-away canopy assembly of claim 1, wherein each of the second extension assemblies includes a tube receiver assembly.

15. The break-away canopy assembly of claim 10, wherein the inner member and an outer member are assembled together with a quick-release button connector.

16. The break-away canopy assembly of claim 1, wherein in an assembled orientation, the first support framework forms an angle with a substantially horizontal line in a range of from about 10° to about 40°.

17. The break-away canopy assembly of claim 1, wherein in an assembled orientation, the second support framework forms an angle with a substantially horizontal line in a range of from about 10° to about 40°.

18. The break-away canopy assembly of claim 1, wherein in an assembled orientation, an angle formed by the first support framework is the same as an angle formed by the second support framework with a substantially horizontal line.

19. The break-away canopy assembly of claim 1, wherein the roof sections are formed from plywood sheets.

20. The break-away canopy assembly of claim 10, wherein an upper surface outer member includes surface features configured to engage a lower surface of the roof section.
